(19) United States
(12) Patent Application Publication
(10) Pub. No.: US 2018/0300657 A1
(43) Pub. Date: Oct. 18, 2018

(54) SYSTEMS AND METHODS OF DISTRIBUTING EVENT TICKETS

(71) Applicant: Nasdaq Technology AB, Stockholm (SE)

(72) Inventor: Scott SCHECHTMAN, New York, NY (US)

(21) Appl. No.: 15/956,160

(22) Filed: Apr. 18, 2018

Related U.S. Application Data
(60) Provisional application No. 62/486,676, filed on Apr. 18, 2017.

(51) Int. Cl. G06Q 10/02; G06Q 30/08

(52) U.S. Cl. CPC G06Q 10/02; G06Q 30/08

(57) ABSTRACT

A resource distribution system is provided that receives a request for a resource. The system generates a plurality of segments for the resource and mutually exclusive conditions for each of the different segments. Different participants are assigned to the separate segments. Real world event data is received and the system determines which conditions for the segments are still valid. When only one participant is left with the associated segments for a given resource, then that participant is notified that they have acquired the resource.

### CROSS REFERENCE TO RELATED APPLICATION(S)

This application claims the benefit of U.S. patent application Ser. No. 62/486,676 filed Apr. 18, 2017, the entire contents of which are incorporated herein by reference.

### TECHNICAL OVERVIEW

The technology described herein relates to a new technique for distributing or handling tickets (e.g., for events). More particularly, the technology described herein relates to generating segments for tickets and providing mutually exclusive conditions that are tied to each of the generated segments.

### INTRODUCTION

Historically concertgoers have enjoyed first-come, first-served access to tickets, initially by waiting in line at ticket outlets, later by telephone, and in recent years via the Internet. The best seats for the most popular acts always cost the most, and to get them you had to camp out or dial and type quickly. For the most part, everyone had a fair shot at tickets with fixed prices set by promoters and venue operators based on what they thought people would pay. Those prices were printed on the ticket stub—the so-called face value.

More recently, the traditional players (e.g., such as Ticketmaster Auctions) have been looking to regain control in what may well be the future of ticketing. This can be viewed as a showdown between the face value of the tickets and “true” market value. The basic principle: the most desirable seats for popular shows are offered in timed auctions to the highest online bidders, with no limit on how high prices can go. In one example, a ticket seller introduced what it calls “dynamic pricing” for tickets to a boxing match in Los Angeles. In other isolated instances there have been auctions for front row seats benefiting charities. But the practice started to catch on more widely when Ticketmaster clients began putting more tickets for more shows up for auction.

A draw-back with existing systems is however the lack of technology that allows for distributing tickets in a manner that depends on one or more conditions that are tied to real world events or real world outcomes. Thus, advances in this area (i.e., in the computer architectures, data structures, and computational processes required to support such functionality) are desired.

### SUMMARY

In certain examples, a computer system is provided. The computer system includes a non-transitory computer-readable storage medium configured to store resource data segment data for each resource (e.g., a ticket). A processing system is also configured to receive, from a first client computer system, a resource submission request to offer a resource for an event to other participants. In response to the resource submission request, the processing system is configured to generate a plurality of segments for the resource and generate a plurality of mutually exclusive conditions that are each associated with a different one of the plurality of generated segments for a given resource. The plurality of segments, and associated conditions, are stored to the non-transitory computer-readable storage medium. The processing system is configured to receive requests from a plurality of participants for different ones of the plurality of generated segments. Participants are assigned to different ones of the plurality of segments and the assignments are stored to the non-transitory computer-readable storage medium. Real world event data is received and based on that data the processing system determines which of plurality of mutually exclusive conditions are no longer possible. The system updates the non-transitory computer-readable storage medium based on the determination. When only one participant is associated with a remaining number of the plurality of mutually exclusive conditions that are possible, a notification is sent to the participant that they have acquired the resource from the resource submission request.

This Summary is provided to introduce a selection of concepts in a simplified form that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 shows ticket deconstruction according to certain example embodiments;

FIG. 2 is an example system architecture diagram according to certain example embodiments;

FIGS. 3A and 3B is a signaling diagram that shows an example process using the system shown in FIG. 2; and

FIG. 4 shows an example computing device that may be used in some embodiments to implement features described herein.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

### Overview

The technology described herein relates to, among other subjects, the segmentation and allocation of resources such as computing resources (compute power, memory, storage, etc.), digital, and/or real world assets (such as tickets to events), and/or other types of assets. In some embodiments, the technology involves auctions for and/or distribution of resources (such as event tickets). In some embodiments, the technology herein relates to an electronic (e.g., automated) auction of resources (e.g., tickets for a given event) that occurs over an electronic communications network (e.g., the Internet). These auctions can be run daily, weekly, monthly, or over any other time period leading up to an event. It will be appreciated that the greater the uncertainty surrounding the event, the more interest there may be in this type of auction.

In certain examples, the techniques herein may be applied to other types of resources besides tickets. For example, the techniques may be used to segment computing resources (compute power, memory, storage, etc.) that are used by customers.

The techniques described herein may work for any type of resource. For ease of description, embodiments/examples involving event tickets will be described herein; however, it should be understood that, in any such embodiments/examples, the techniques may be employed mutatis mutandis with other types of resources.

The techniques described herein may have particular benefit for resources with uncertainties around them. For example, in embodiments that relate to events (such as sporting events or concerts), the uncertainties may include items such as who will be playing, what the location will be, what the weather will be, and the like. In certain examples, a ticket (which may be an asset) is deconstructed into a number of mutually exclusive, collectively exhaustive segments (which may also be termed components or elements). The segments for a given ticket (or group of tickets) are then auctioned off separately. Once the segments for a ticket are generated, the inventory of those segments is tracked throughout the auction process until at least one of the segments is converted back into a ticket for the event.

In certain examples, the segments may be grouped and auctioned as a block. This may provide the ability for clients to more particularly customized what outcomes are of interest to them and to balance a possible event outcome that is spread out across multiple different generated segments. This may thus create one segment from the clients perspective that is composed of multiple generated segments for the ticket.

Participants (clients) for the auction(s) can include both buyers and sellers of full, or partial, tickets. Partial tickets may correspond to one or more segments of a full ticket that has been generated for the auction. In certain instances, these may be thought of as a coupon, or conditional ticket, entitling the owner of the coupon or conditional ticket to a full ticket under certain circumstances (such as if the weather if greater than 32 degrees Fahrenheit at the time of kickoff, or if a certain team will be playing for the event).

In certain examples, full tickets for sale can be managed in an inventory that is depleted as the series of auctions are settled sequentially in the lead-up to the ticket for the event. It may be the case that some tickets are only partially sold by the time the event begins, but this is likely to be preferable to not selling any portion of these tickets as their value may be decreased (or even worthless) upon the start of the event.

In certain examples, in order manage ticket inventory effectively, the payout of coupons may be increased, or decreased, based on the amount of ticket inventory that the operator of the auction has available to sell. This increase, or decrease, will occur after the auction is closed, but before settlement occurs and it will determine, by triggering the limit prices of participants, the amount of inventory matched by the auction.

In certain examples, (e.g., depending on regulations or other considerations), partial tickets or ticket segments can be re-sold in subsequent auctions or in a more traditional market.

The deconstruction of tickets can allow for the sale of pieces, some of which are based on outcomes that are very likely to occur and others of which are based on outcomes that are extremely unlikely. The more likely an event, the more of a premium a customer may be willing to pay for such a ticket segment. This can result not only in making expensive tickets more accessible to a wider customer base, but it can also result in the sale of tickets for a greater value (i.e., the whole may be worth less than the some of these parts).

In certain examples, the instruments that are used in the auction may be terms electronic “coupons” or electronic “conditional tickets” in the case of people looking to attend the events. In certain examples, owners of tickets use the techniques herein as “event insurance” or “ticket insurance.” For example, a ticket owner may opt to sell segments of their tickets that represent match-ups, weather (or other conditions) that would leave the ticket owner disinclined to attend.

An auction can be used to create a more liquid market for ticket sales. For example, an auction may proceed by accepting orders or bids from different participants. When the auction closes, a winner and corresponding auction settlement price may be determined.

While all types of events can have ticket sales managed through the techniques herein, those events with significant uncertainties tied to them, e.g., playoffs and tournaments where participants remain unknown until shortly (e.g., hours, days, weeks, or even months) before the event begins, may benefit more from the techniques herein. By deconstructing each ticket into segments that can be sold individually or in groups, a range of new ways that ticket owners and ticket seekers can interact can be realized.

For example, before an NFL season begins there are 256 possible Super Bowl match-ups that can be sold individually, or in groups. In such an instance (or other instances), the techniques described herein may can balance investment across ticket segments in a way that allows for the sale of individual segments, or bundles of segments, that could be marketed as individual products. Segments may be (or must be) mutually exclusive and collectively exhaustive. The following are different types of products that may be derived from an underlying ticket.

Match-Up Coupon: A match-up coupon would entitle the buyer to a full ticket only if two (or more) specific teams, athletes, or participants were to face each other in a particular contest or event. For example, a customer could reserve a ticket to the US Open final only if the Williams sisters were to face each other; because this particular match-up is one of hundreds of possible match-ups, even a courtside seat could be very inexpensive (e.g., if there is low demand for a particular matchup or desire to see a given participant).

Team (or individual) Coupon: A team coupon would entitle the buyer to a ticket only if a team that they specify participates in a particular contest. For example, a customer could reserve a ticket to the College Football Playoff National Championship, but only if Alabama will be participating in that game.

Proximity Coupon: A proximity coupon would entitle the buyer to a ticket only if the event in question takes place within a certain radius of a location specified by that buyer. For example, a customer could reserve a ticket to Game 1 of the MLB National League Championship Series, but only if that game takes place within 250 miles of Philadelphia.

Customized Coupon: A customized coupon is any coupon that mixes and matches features from the coupons described above. For example, a customer could reserve a ticket to the Super Bowl, but only if the New England Patriots face a team in the NFC East. As another example, a team coupon and a proximity coupon could be combined so that a customer could reserve a ticket to Game 1 of the NBA Eastern Conference finals, but only if Game 1 is played at Madison square garden (MSG)—e.g., requiring the Knicks to not only participate, but to have home court advantage in the series.

Event Insurance: Event Insurance is a product that would allow a customer already in possession of a ticket to an event to sell coupons against the ticket to avoid paying to attend an unappealing contest. For example, the holder of a ticket to the Final Four could sell the segments of that ticket that corresponds to North Carolina being eliminated prior to that stage of the tournament.

While the techniques herein generally tie conditions for segments to real world events or data (e.g., which team will be playing in a particular event), other types of conditions not based on real world actions may be used.

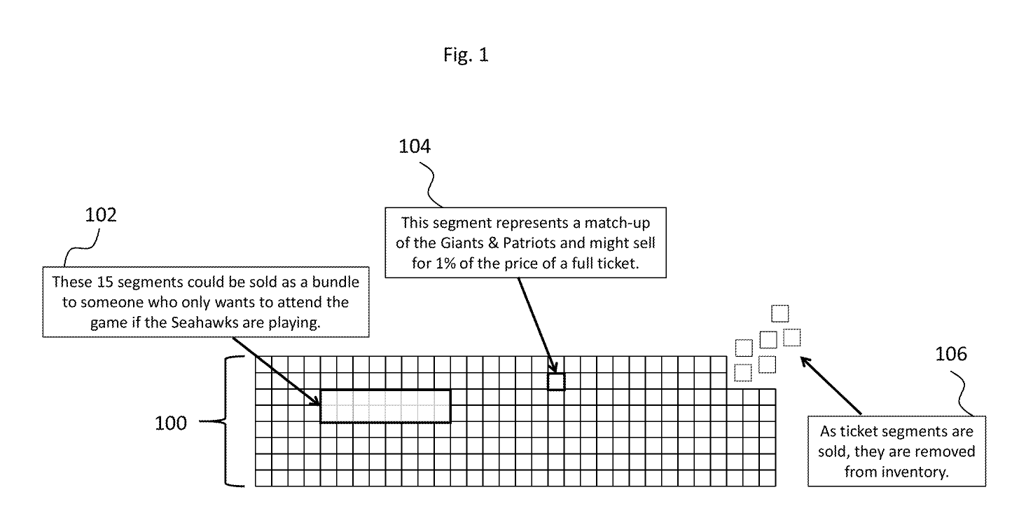

### FIG. 1

FIG. 1 shows how a ticket (or a group of tickets) may be deconstructed. A given ticket 100 for an event (e.g., the Super Bowl) may be deconstructed into various segments represented by each square in FIG. 1. Segments of a ticket may be bunched together as represented by bundle 102 where 16 segments represent the segments of the ticket that correspond to the Seahawks playing in the game that this ticket is for (e.g., each segment of the 16 representing the Seahawks playing against a different team from the AFC). Another segment 104 may represent a match-up of two specific participants—the New York Giants and New England Patriots playing in the Super Bowl. As a potential purchaser of this segment is buying just the segment—the segment might sell for 1% of the price of a full ticket. Segments 106 represent those segments that have been sold and thus removed from the inventory of possible segments.

It will be appreciated that in certain example embodiments, the segments that are sold (either individually or in a bundle) would be mutually exclusive. For example, if the Seahawks block is sold (e.g., representing the Seahawks playing in the Super Bowl against any other team), then another individual segment of the Seahawks versus the Browns would not be sold because the previously sold block would overlap with the specific Seahawks versus the Browns segment. Of course, another set of segments may be generated for a different “ticket” that would allow the segments to be split up differently.

In certain examples, the ticket 100 may be a ticket that has been purchased by an individual from the promoter or organizer. In certain examples, ticket 100 may be a ticket that is sold by the promoter or organizer of an event.

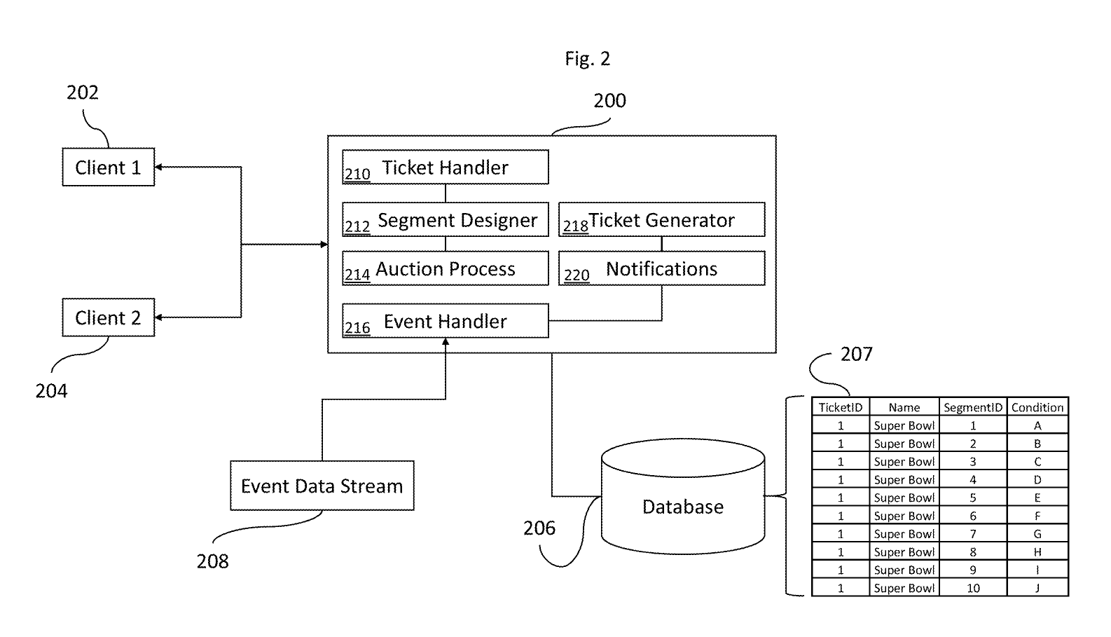

In certain examples, data for each ticket is stored in a database with a corresponding unique identifier (e.g., a TicketID or ResourceID to distinguish it from other tickets). Each segment for that ticket may have a corresponding identifier (e.g., a segmentlD). This is shown in FIG. 2. As described herein, other types of resources may be used in conjunction with the described techniques. Thus, for example, the resource that is being segmented may be represented in the system as a digital resource.

An example process (e.g., embodied as a computer program or computer process that executes on an appropriate computer hardware resources) may include one or more of the following steps: 1) receiving an electronic data message from a client computer system that includes a request to sell a given ticket, 2) constructing segments for the ticket (or multiple tickets), 3) beginning an auction process for the segments, 4) receiving auction bids for one or more of the auction segments, 5) storing the bids into a database, 6) closing the auction process, 6) determining which bids for one or more of the segments were the “winning” bids, 7) assigning segments to different participants, 8) receiving notifications regarding real-world events that affect the ticket (e.g., that the Browns are mathematically eliminated from the playoffs and thus it is impossible for them to play in the Super Bowl), 9) notifying participants of changes in the ticket including, for example, that their segment is no longer possible or that their segment will be “turned into” a ticket, 10) generating a valid ticket that corresponds to the fulfilled requirements for a segment, 11) transmitting or notifying a participant that they have a valid ticket for the event. One, or more, or all of the above steps may be carried out by a ticket distribution computer system.

### FIG. 2

FIG. 2 is an example system architecture diagram according to certain example embodiments. Ticket distribution computer system 200 (also called a resource distribution computer system in certain examples) includes multiple different modules or components (which may be combined into a single component in certain example embodiments) that operate to carry out the functionality described herein.

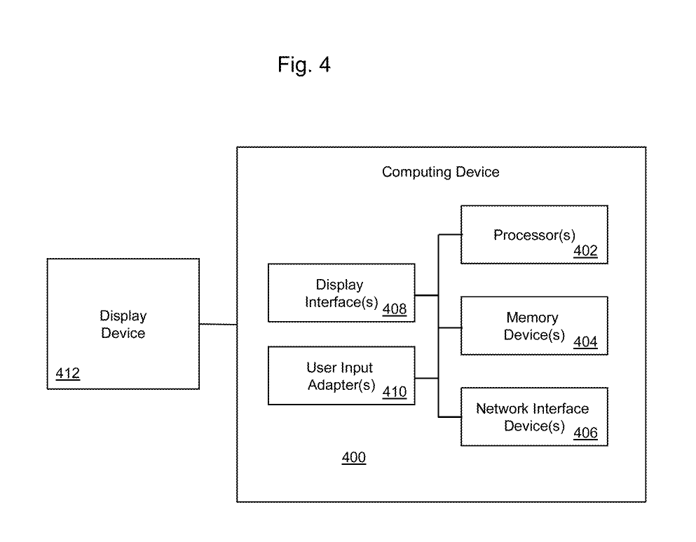

Client computer systems 202 and 204 (respectively operated by client 1 and 2) communicate with ticket distribution computer system 200. Client computer systems 202 and 204 are an example of computing device 400 shown in FIG. 4. Client computer systems are generally remotely located from ticket distribution computer system 200 and communicate with system 200 via an electronic data communications network (e.g., the Internet).

In the example shown in FIG. 2, client 1 operates a client computer system to submit a ticket for auction. Client 2 represents those clients (and their computer systems) that will participate in the auction process for the segments generated for that ticket (which may be multiple tickets). Client computer systems may include desktop computer, tablets, smart phones, and other types of computing devices.

Ticket distribution computer system 200 includes ticker handler 210 that processes requests from clients to sell one or more tickets. This may include receiving the request to sell a ticket, validating the ticket, and storing the ticket information into database 206.

Ticket handler 210 may use segment designer 212 to generate the segments that will be auctioned according to the embodiments described herein. As noted herein, the segments for a given ticket (or a group of tickets) have a collection of mutually exclusive conditions. In other words, each segment for a given ticket has a unique (e.g., unique within the set of segments for a single ticket) set (e.g., one or more) of conditions that are linked to that segment in order for the segment to be valid. Each of the unique conditions are also mutually exclusive with respect to one another such that no two segments for the same ticket can be satisfied once all of conditions have been resolved.

For example, each of the generated segments for a given ticket may have a different event trigger (e.g., a condition for a segment that is triggered upon reception of a given event) that is mutually exclusive with the other triggers for other segments. The event triggers may be as simple or as complex as needed based on specific conditions for the generated segments. One example of an event trigger, may relate to teams (or players) that will play in the championship game of a tournament. The event triggers may include the following examples that are discussed above, a team (or individual) coupon, a match-up coupon, a proximity coupon, a customized coupon, and other types of variations that would trigger one of plural mutually exclusive segments.

In certain example embodiments, the generation of the segments for a ticket may include initially specifying the condition categories and the individual parameters for the respective conditions. For example, “weather” may be a first condition with parameter values for temperature ranges. A second condition may relate to teams (or players) that will be at the event, and each parameter value for this condition may be the individual teams. A third condition may be the location of the event with individual parameter values for different cities. All three of these conditions may be used to generate an appropriate number of segments such that each segment is associated with a unique, mutually exclusive set of conditions (e.g., a unique set of conditions for A, B, C).

In any event, once the segments for a ticket (or tickets, or an event with tickets) have been generated or designed, they may be stored to database 206 and then an auction process for those segments may be carried out by the auction process module 214. An example table 207 that includes segment and ticket information is shown in FIG. 2. Of course different types of table designs (e.g., database architectures) may be used according to the needs of a particular project or system. In this example, each row represents a different segment (indicated by identifiers 1-10) for a ticket and event, and a corresponding condition (e.g., A-J) for that segment. As noted above, each condition may be mutually exclusive with other conditions for the same ticket. Accordingly, for example, the segments for a ticket would not include one segment for a sunny condition and another segment for team A because both of those conditions may be satisfied. Instead, the segments must have mutually exclusive conditions. Note, however, that the conditions may be relatively complex. Thus, each condition may have both the weather and team playing as a factor. This would allow one client to acquire segments for sunny games (e.g., regardless of the teams playing) while allowing other clients acquire segments for a particular team (e.g., regardless of the weather). In certain examples, the different clients may then bid on the overlapping segments (e.g., those where team A plays and it is sunny).

Returning to FIG. 2, the ticket distribution computer system 200 may begin accepting (or processing) bids for the different segments during the auction process. The information for each bid may be stored to database 206. Thus, for example, the auction process module 214 may also be responsible for closing the auction and subsequently determining which bids for a given segment are successful. The auction process module 214 may use the notification module 220 to notify clients and/or the original ticket submitter regarding the results of the auction (e.g., that a given bid was successful, or that the ticket has successfully been auctioned).

In certain example embodiments, the auction process module 214 may be configured to accept new bids after an initial auction process. For example, in an NCAA tournament example, no clients may bid on a segment that includes the 16^{th} seed reaching the Final Four. But if the 16^{th} seed does beat a number one seed a new auction may be reintroduced to allow users to bid on previously unbid segments.

After completion of the auction, the ticket distribution system 200 uses event handler 216 to receive data from event data stream 208. Event data stream 2080 provides data regarding events that may affect the segments. For example, if tickets for the final four in the NCAA basketball tournament were segmented based on the participants in the Final Four, then the results of the first round—elite eight games may be reported to the ticket distribution computer system 200 by the event data stream. This information may be used to update the segment data stored in the database 206 and eliminate those segments that are now impossible. The clients associated with eliminated segments may be notified that those segments are no longer possible via notification module 220.

Once a segment is the only segment remaining that is valid (or only one client is associated with the remaining segments), then the ticket generator module 218 may generate a final ticket(s) for the event in question. For example, the ticket generator module 218 may generate an electronic ticket (e.g., a barcode, etc.) and send the ticket to the client. The ticket generator may also be used to prompt the sending of a physical ticket to the client upon determination that the client has “won” the ticket. Thus, in the case of the NCAA tournament example above, tickets may be generated for the 2 final four games and the championship game. The ticket data (or physical tickets) may be set to the winning client via the notification module 220.

In certain examples, the event data stream 208 may include manual entry by a user. In other words, a user may enter event data directly into the ticket distribution computer system 200 (e.g., by using a mouse/keyboard). In certain examples, a user may mark off a segment as not being completed (e.g., by closing out a segment). This action may then trigger a notification to the client that successfully bid for that segment of the original ticket.

In many places in this document, including but not limited to in the above description of FIG. 2, software modules and actions performed by software modules are described. This is done for ease of description; it should be understood that, whenever it is described in this document that a software module performs any action, the action is in actuality performed by underlying hardware elements (such as a processor and a memory device) according to the instructions that comprise the software module. Further details regarding this are provided below in, among other places, the description of FIG. 4.

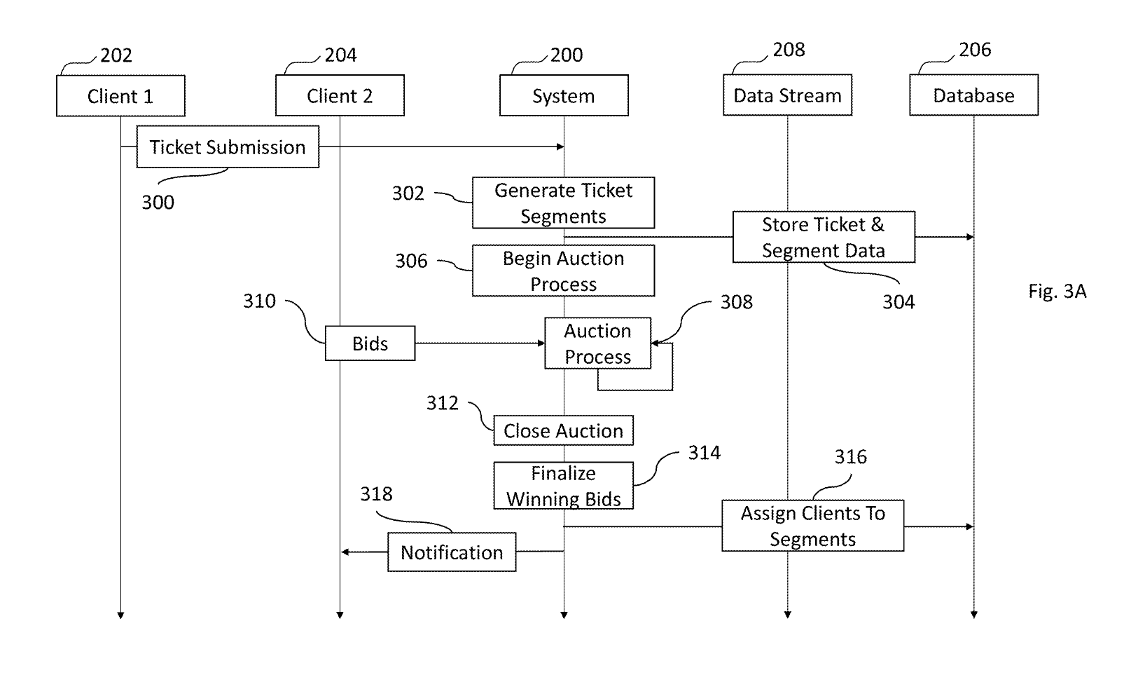

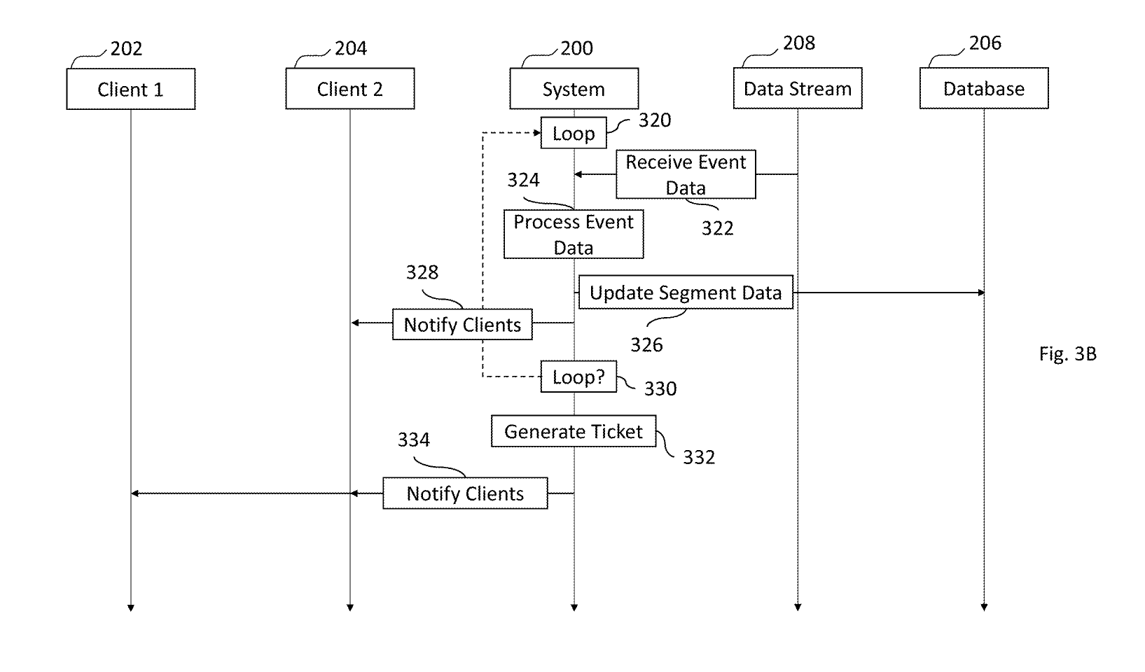

### FIG. 3

FIGS. 3A and 3B are signaling diagrams that show an example process using the system shown in FIG. 2.

In 300, client 1 submits one or more tickets that are to auctioned or otherwise distributed to other participants or clients according the techniques herein. The submission is received by the ticket distribution computer system 200 that then generates a plurality of segments for the one or more tickets at 302. In certain examples multiple tickets may be treated a single group. Thus, for example, 4 tickets may be grouped together such that the segments generated for those tickets are linked to those 4 tickets collectively. In other examples, different segments may be created for individual ones of the tickets. For example, one ticket may be segmented based on the teams that will play, another ticket may be segmented based on the weather during the game, and another may be based on a combination of these two events. The generated segments (and ticket information) are then saved to database 206 at 304.

At 306, an auction process is started. This may include notifying interested parties and/or making a webpage or the like available for clients to bid on particular segments that have been generated. The auction process proceeds at 308 while accepting bids 310 for segments from client 2 (which represents the diverse clients that are interested in bidding on segments). The auction process 308 continues until it is closed at 312.

In certain examples, clients may specify those conditions that they wish to bid on. The specification of conditions may be directly linked to the conditions for the segments. For example, a client may specify tickets for the Seahawks and Seahawks is o parameter value for the team condition for the segments.

In certain examples, the system may translate the desires of a client to the parameter values for conditions for the segments. For example, a client may enter that they only want segments if the event is 50 miles from their home. While such a condition may not be directly represented in the conditions for the various segments, the system may determine (for example) those cities that are within 50 miles of the client. Those cities may then be selected as segments to be bid on.

In certain examples, a client may not care about a specific condition for the segments. In such a case, the parameter values for the condition may be a wild card. Thus, if segments have a team condition and weather condition, then the client may specify a team (the Seahawks) and not indicate that weather matters. In such cases, the client may in actuality be “bidding” on two (or more) segments. For example, two segments may include a first segment with a condition(s) where the parameter values specify Seahawks and rainy weather and a second segment with a condition(s) where the parameter values specify Seahawks and sunny weather. Thus, even though there are two segments they may be presented as a single segment with a single condition (the team to be playing) to the client.

It will be appreciated that different types of auctions may be employed such as, for example, blind auctions (either using the highest or another price, such as the second highest price), open ascending auctions, open descending auctions, buyout auctions, and other types of auctions.

Closing the auction at 312 may occur after a set time (e.g., 1 hour, 1 day, 1 week, etc.) or once another condition has been satisfied (e.g., once a threshold number of bids have been received).

Once the auction is closed, then, at 314, the bids are finalized and the winning bids for individual segments (or groups of segments) may be determined. Based on the finalization of the auction, clients are then assigned to the previously generated segments at 316. In other words, for example, a particular client is associated with a particular segment and that association is stored to database 206.

The winning clients (and/or those that were unsuccessful) are notified at 318.

In certain examples, the auction process may be skipped and each segment may have a set price associated with it (e.g., $10.00). In certain examples, a segment may have a buyout price in combination with the auction process. Other types of techniques for assigning generated segments of a ticket to a use may also be used.

At 320, a loop is started that waits for events that may trigger the removal of segments from contention for the ticket and/or may trigger segments that change into the corresponding ticket.

Once the loop at 320 starts, the ticket distribution computer system 200 receives event data at 322 from the data stream 208. In the case of sports games in which the triggers for segments are based on the teams, this may include the results of previous games or matches. Data received at 322 may be processed by the system 200 at 324 to determine, for example, which segments are no longer possible. For example, if a team in the NCAA Men's basketball tournament loses in the first round, then all of the segments that require that team may be closed out (e.g., as they are no longer possible) and recorded to database at 326. Those clients 204 associated with the closed out segments may be notified at 328 that a given segment no longer can be turned into the ticket.

At 330, the ticket distribution computer system 200 may determine if there are still multiple open segments and/or if there are multiple clients associated with open segments. If there are multiple open segments and/or associated clients, then the loop 330 returns to 320 where the ticket distribution computer system continues to receive event data.

If there is only one segment left and/or one client that is associated with the remaining segments, then at 330, the ticket distribution computer system 200 may end the loop and begin the process of generating a ticket for the “winning” client at 332.

At 332, a ticket for the event in question may be generated for the client that won the ticket. This may include generating an electronic ticket and sending that ticket to the client via an email, text, or other electronic communication method at 334. In certain examples, 334 may include generating a physical ticket and mailing or otherwise delivering the physical ticket to the client. In certain examples, the original seller of the ticket (client 1) may, as part of submitting the ticket at 300, be required to put the ticket into escrow. Accordingly, upon successful completion of the auction, the ticket may be released to the winning client at 332 and the winning client notified at 334. In certain examples, the original submitter (client 1 202) of the ticket may be notified of the successful auction at 334.

### FIG. 4

FIG. 4 is a block diagram of an example computing device 400 (which may also be referred to, for example, as a “computing device,” “computer system,” or “computing system”) according to some embodiments. In some embodiments, the computing device 400 includes one or more of the following: one or more processors 402; one or more memory devices 404; one or more network interface devices 406; one or more display interfaces 408; and one or more user input adapters 410. Additionally, in some embodiments, the computing device 400 is connected to or includes a display device 412. As will explained below, these elements (e.g., the processors 402, memory devices 404, network interface devices 406, display interfaces 408, user input adapters 410, display device 412) are hardware devices (for example, electronic circuits or combinations of circuits) that are configured to perform various different functions for the computing device 400.

In some embodiments, each or any of the hardware processors 402 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 402 uses an instruction set architecture such as x86 or Advanced RISC Machine (ARM). Multiple computer systems may collectively form a cloud computer system and each one of the computer systems is configured to host one or more virtual machines (which are also referred as instances herein).

In some embodiments, each or any of the memory devices 404 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 402). Memory devices 404 are examples of non-volatile computer-readable storage media.

In some embodiments, each or any of the network interface devices 406 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 408 is or includes one or more circuits that receive data from the processors 402, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 412, which displays the image data. Alternatively or additionally, in some embodiments, each or any of the display interfaces 408 is or includes, for example, a video card, video adapter, or graphics processing unit (GPU).

In some embodiments, each or any of the user input adapters 410 is or includes one or more circuits that receive and process user input data from one or more user input devices (not shown in FIG. 4) that are included in, attached to, or otherwise in communication with the computing device 400, and that output data based on the received input data to the processors 402. Alternatively or additionally, in some embodiments each or any of the user input adapters 410 is or includes, for example, a PS/2 interface, a USB interface, a touchscreen controller, or the like; and/or the user input adapters 410 facilitates input from user input devices (not shown in FIG. 4) such as, for example, a keyboard, mouse, trackpad, touchscreen, etc.

In some embodiments, the display device 412 may be a Liquid Crystal Display (LCD) display, Light Emitting Diode (LED) display, or other type of display device. In embodiments where the display device 412 is a component of the computing device 400 (e.g., the computing device and the display device are included in a unified housing), the display device 412 may be a touchscreen display or non-touchscreen display. In embodiments where the display device 412 is connected to the computing device 400 (e.g., is external to the computing device 400 and communicates with the computing device 400 via a wire and/or via wireless communication technology), the display device 412 is, for example, an external monitor, projector, television, display screen, etc.

In various embodiments, the computing device 400 includes one, or two, or three, four, or more of each or any of the above-mentioned elements (e.g., the processors 402, memory devices 404, network interface devices 406, display interfaces 408, and user input adapters 410). Alternatively or additionally, in some embodiments, the computing device 400 includes one or more of: a processing system that includes the processors 402; a memory or storage system that includes the memory devices 404; and a network interface system that includes the network interface devices 406.

The computing device 400 may be arranged, in various embodiments, in many different ways. As just one example, the computing device 400 may be arranged such that the processors 402 include: a multi (or single)-core processor; a first network interface device (which implements, for example, WiFi, Bluetooth, NFC, etc.); a second network interface device that implements one or more cellular communication technologies (e.g., 3G, 4G LTE, CDMA, etc.); memory or storage devices (e.g., RAM, flash memory, or a hard disk). The processor, the first network interface device, the second network interface device, and the memory devices may be integrated as part of the same SOC (e.g., one integrated circuit chip). As another example, the computing device 400 may be arranged such that: the processors 402 include two, three, four, five, or more multi-core processors; the network interface devices 406 include a first network interface device that implements Ethernet and a second network interface device that implements WiFi and/or Bluetooth; and the memory devices 404 include a RAM and a flash memory or hard disk.

As previously noted, whenever it is described in this document that a software module or software process performs any action, the action is in actuality performed by underlying hardware elements according to the instructions that comprise the software module. Consistent with the foregoing, in various embodiments, each or any combination of a ticket distribution computer system, a client computer system, an auction computer system, a database, etc. each of which will be referred to individually for clarity as a “component” for the remainder of this paragraph, are implemented using an example of the computing device 400 of FIG. 4 (or a plurality of such devices). In such embodiments, the following applies for each component: (a) the elements of the computing device 400 shown in FIG. 4 (i.e., the one or more processors 402, one or more memory devices 404, one or more network interface devices 406, one or more display interfaces 408, and one or more user input adapters 410), or appropriate combinations or subsets of the foregoing) are configured to, adapted to, and/or programmed to implement each or any combination of the actions, activities, or features described herein as performed by the component and/or by any software modules described herein as included within the component (e.g., each of ticket handler 210, segment designer 212, auction process module 214, event handler 216, ticket generator 218, and/or notification module 220); (b) alternatively or additionally, to the extent it is described herein that one or more software modules exist within the component, in some embodiments, such software modules (as well as any data described herein as handled and/or used by the software modules) are stored in the memory devices 404 (e.g., in various embodiments, in a volatile memory device such as a RAM or an instruction register and/or in a non-volatile memory device such as a flash memory or hard disk) and all actions described herein as performed by the software modules are performed by the processors 402 in conjunction with, as appropriate, the other elements in and/or connected to the computing device 400 (i.e., the network interface devices 406, display interfaces 408, user input adapters 410, and/or display device 412); (c) alternatively or additionally, to the extent it is described herein that the component processes and/or otherwise handles data, in some embodiments, such data is stored in the memory devices 404 (e.g., in some embodiments, in a volatile memory device such as a RAM and/or in a non-volatile memory device such as a flash memory or hard disk) and/or is processed/handled by the processors 402 in conjunction, as appropriate, the other elements in and/or connected to the computing device 400 (i.e., the network interface devices 406, display interfaces 408, user input adapters 410, and/or display device 412); (d) alternatively or additionally, in some embodiments, the memory devices 402 store instructions that, when executed by the processors 402, cause the processors 402 to perform, in conjunction with, as appropriate, the other elements in and/or connected to the computing device 400 (i.e., the memory devices 404, network interface devices 406, display interfaces 408, user input adapters 410, and/or display device 412), each or any combination of actions described herein as performed by the component and/or by any software modules described herein as included within the component.

Consistent with the preceding paragraph, as one example, in an embodiment where an instance of the computing device 400 is used to implement a ticket distribution computer system, the memory devices 404 could load or store a database that includes ticket information, segments for tickets, bids for segments, or other data or programmed instructions as described herein. Processors 402 could be used to (in conjunction with appropriately configured software) to execute the auction process and the functionality associated therewith.

The hardware configurations shown in FIG. 4 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 4, (e) via other hardware arrangements, architectures, and configurations, and/or via combinations of the technology described in (a) through (e).

### Technical Advantages of Described Subject Matter

In certain example embodiments, the techniques described herein allow for more efficient allocation of tickets for real-world events and provide a new and improved technique that allows participants to acquire such tickets. In particular, due to the segmentation of the tickets, a greater variety of clients or participants may be able to obtain tickets that would otherwise not be obtainable. The techniques herein also allow for a more efficient distribution of tickets that may more closely match the desires of such tickets. The techniques herein are facilitated by the creation of multiple mutually exclusive segments for each ticket that is to be transacted.

The techniques herein allow for an improved process of distributing and/or auctioning tickets based on real-world input that is used to determine how the tickets will be distributed. For example, a person may only wish to go to a playoff game (e.g., the NFL/NBA/MLB) if a certain team will be playing.

### Selected Terminology

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Additional Applications of Described Subject Matter

Although process steps, algorithms or the like, including without limitation with reference to FIGS. 1-4 or the description herein, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

As noted above, while many embodiments and examples are provided herein with respect to event tickets, the techniques herein may be applied to other types of resources besides tickets. For example, computing resources (e.g., CPU clock cycles or other computing power, memory, disk space) in a cloud computing environment or other computing system may be segmented and processed according the techniques herein. In other examples, the resources may represent housing (e.g., houses, apartments, or rooms for rent), similar resources, and/or other resources.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A resource distribution computer system comprising:
a non-transitory computer-readable storage medium configured to store digital resource data for a resource and segment data for the resource;
a processing system that includes at least one hardware processor, the processing system configured to:
receive, from a first client computer system, a resource submission request to offer the resource to other participants;
in response to the resource submission request, generate a plurality of segments for the resource and generate a plurality of mutually exclusive conditions that are each associated with a different one of the plurality of generated segments for a given resource;
store the plurality of segments, and associated conditions, to the non-transitory computer-readable storage medium;
receive, from remote computing systems, requests for different ones of the plurality of generated segments;
assign participants to different ones of the plurality of segments and store the assignments to the non-transitory computer-readable storage medium;
receive, via a transceiver, real world event data;
determine, based on the received real world event data, which of plurality of mutually exclusive conditions are no longer possible and update the non-transitory computer-readable storage medium based on the determination; and
as a result of determining that only one participant is associated with a remaining number of the plurality of mutually exclusive conditions that are possible, cause a notification to be sent to the participant that the request for the resource has been accepted.

2. The resource distribution computer system of claim 1, wherein the real world event data corresponds to a plurality of different events for which different instances of real world event data are received at different times, wherein the processing system is further configured to:
upon reception of each instance, perform the determination of which ones of the plurality of mutually exclusive conditions are no longer possible based on the received instance.

3. The resource distribution computer system of claim 1, wherein the processing system is further configured to:
in response to determination that a segment is no longer possible, transmit a notification to a participant that was assigned to the segment.

4. The resource distribution computer system of claim 1, wherein the processing system is further configured to:
receive a request from a first participant for a real world condition that encompasses multiple segments from the plurality of generated segments;
group the multiple segments for the resource into a single group that is then stored in association with the first participant.

5. The resource distribution computer system of claim 1, wherein at least some of the plurality of conditions are associated with at least two conditions.

6. The resource distribution computer system of claim 1, wherein the processing system is further configured to:
start an auction process for the plurality of segments;
conduct the auction process, wherein the received requests are bids for different ones of the plurality of generated segments; and
finalize the auction process, wherein the participants are assigned segments based on their respective bids for each of the plurality of segments.

7. The resource distribution computer system of claim 1, wherein the plurality of mutually exclusive conditions relate to at least one of the following: 1) a future determination for a location in which an event to which the resource is for will be held, and 2) a future determination of at least one participant for the event.

8. A method of distributing resources using a resource distribution computer system, the method comprising:
receiving, from a first client computer system, a resource submission request to offer a resource to other participants;
in response to the resource submission request, generating a plurality of segments for the resource and generating a plurality of mutually exclusive conditions that are each associated with a different one of the plurality of generated segments for a given resource;
storing the plurality of segments, and associated conditions, to a non-transitory computer-readable storage medium;
receiving, from remotely located computer systems, requests for different ones of the plurality of generated segments;
assigning participants to different ones of the plurality of segments and storing the assignments to the non-transitory computer-readable storage medium;
receiving, via a transceiver, real world event data;
determining, based on the received real world event data, which of plurality of mutually exclusive conditions are no longer possible and update the non-transitory computer-readable storage medium based on the determination; and
as a result of determining that only one participant is associated with a remaining number of the plurality of mutually exclusive conditions that are possible, causing a notification to be sent to the participant that they have acquired the resource from the resource submission request.

9. The method of claim 8, wherein the real world event data corresponds to a plurality of different events for which different instances of real world event data are received at different times, the method further comprising:
upon reception of each instance, performing the determination of which ones of the plurality of mutually exclusive conditions are no longer possible based on the received instance.

10. The method of claim 8, further comprising:
in response to determination that a segment is no longer possible, transmitting a notification to a participant that was assigned to the segment.

11. The method of claim 8, further comprising:
receiving a request from a first participant for a real world condition that encompasses multiple segments from the plurality of generated segments;
grouping the multiple segments for the resource into a single group that is then stored in association with the first participant.

12. The method of claim 8, wherein at least some of the plurality of conditions are associated with at least two conditions.

13. The method of claim 8, further comprising:
starting an auction process for the plurality of segments;
conducting the auction process, wherein the received requests are bids for different ones of the plurality of generated segments; and
finalizing the auction process, wherein the participants are assigned segments based on their respective bids for each of the plurality of segments.

14. The method of claim 8, wherein the plurality of mutually exclusive conditions relate to at least one of the following: 1) a future determination for a location in which an event to which the resource is for will be held, and 2) a future determination of at least one participant for the event.

15. A non-transitory computer-readable storage medium that stores computer executable instructions for use with a resource distribution computer system that includes at least one hardware processor, the stored instructions comprising instructions that are configured to cause the at least one hardware processor to:
receive, from a first client computer system, a resource submission request to offer a resource to other participants;
in response to the resource submission request, generate a plurality of segments for the resource and generate a plurality of mutually exclusive conditions that are each associated with a different one of the plurality of generated segments for a given resource;
store the plurality of segments, and associated conditions, to a non-transitory computer-readable storage medium that is coupled to the resource distribution computer system;
receive requests for different ones of the plurality of generated segments;
assign participants to different ones of the plurality of segments and store the assignments to the non-transitory computer-readable storage medium;
receive, via a transceiver, real world event data;
determine, based on the received real world event data, which of plurality of mutually exclusive conditions are no longer possible and update the non-transitory computer-readable storage medium based on the determination; and
as a result of determining that only one participant is associated with a remaining number of the plurality of mutually exclusive conditions that are possible, cause a notification to be sent to the participant that they have acquired the resource from the resource submission request.

16. The non-transitory computer-readable storage medium of claim 15, wherein the real world event data corresponds to a plurality of different events for which different instances of real world event data are received at different times, wherein the stored instructions comprise further instructions that are configured to:
upon reception of each instance, perform the determination of which ones of the plurality of mutually exclusive conditions are no longer possible based on the received instance.

17. The non-transitory computer-readable storage medium of claim 15, wherein the stored instructions comprise further instructions that are configured to:
in response to determination that a segment is no longer possible, transmit a notification to a participant that was assigned to the segment.

18. The non-transitory computer-readable storage medium of claim 15, wherein the stored instructions comprise further instructions that are configured to:
receive a request from a first participant for a real world condition that encompasses multiple segments from the plurality of generated segments;
group the multiple segments for the resource into a single group that is then stored in association with the first participant.

19. The non-transitory computer-readable storage medium of claim 15, wherein at least some of the plurality of conditions are associated with at least two conditions.

20. The non-transitory computer-readable storage medium of claim 15, wherein the stored instructions comprise further instructions that are configured to:
start an auction process for the plurality of segments;
conduct the auction process, wherein the received requests are bids for different ones of the plurality of generated segments; and
finalize the auction process, wherein the participants are assigned segments based on their respective bids for each of the plurality of segments.
